(19) United States
(12) Patent Application Publication
(10) Pub. No.: US 2020/0103965 A1
(43) Pub. Date: Apr. 2, 2020

(54) Method, Device and System for Controlling Interaction Control Object by Gaze

(71) Applicant: BEIJING 7INVENSUN TECHNOLOGY CO., LTD., Beijing (CN)

(72) Inventors: Lin LIU, Beijing (CN); Linchan QIN, Beijing (CN); Tongbing HUANG, Beijing (CN)

(21) Appl. No.: 16/699,776

(22) Filed: Dec. 2, 2019

(30) Foreign Application Priority Data
Nov. 30, 2018 (CN) 201811460215.6

(51) Int. Cl. G06F 3/01; G06T 7/73; G06F 3/0482

(52) U.S. Cl. CPC G06F 3/013; G06T 2207/30201; G06F 3/0482; G06T 7/73

(57) ABSTRACT

The disclosure discloses a method, device and system for controlling an interaction control object by eye gaze. The method includes that: at least one interaction control object required by interaction of a target application is displayed, the interaction control object required by interaction including an information association module and an information determination module, the information association module being configured to receive a selection instruction for selecting the interaction control object required by interaction from a user and the information determination module being configured to receive a confirmation instruction for confirming the interaction control object required by interaction from the user; a first gaze duration associated with the information association module is determined according to gaze information of eye gaze; when it is determined that the first gaze duration reaches a first predefined duration, a second gaze duration associated with the information determination module is acquired; and when it is determined that the second gaze duration reaches a second predefined duration, an operation corresponding to the interaction control object required by interaction is completed.

The present application claims benefit of Chinese Patent Application No. 201811460215.6, submitted to the Patent Office of the People's Republic of China on Nov. 30, 2018, and entitled “Method, device and system for controlling interaction control object by eye gaze”, the contents of which are hereby incorporated by reference in its entirety.

### TECHNICAL FIELD

The embodiments of disclosure relate to the field of eye tracking, and particularly to a method, device and system for controlling an interaction control object by eye gaze,

### BACKGROUND

Along with rapid development of computer technologies, an eye tracking technology has also been constantly developed. At present, the eye tracking technology may be extensively applied to human-computer interaction. For example, a user gazes at an application on a display of a computer to control the computer to start the application. In a conventional art, human-computer interaction may be implemented through an eye control system. An existing eye control system mainly gives an instruction based on a gaze duration when a user gazes at a specific target. For example, a display device of the eye control system may display icons of a plurality of application programs or software programs, and if a gaze duration when the user keeps gazing on a certain icon reaches a predetermined time, the eye control system recognizes that the user gives a determination instruction for selecting the icon.

However, before human-computer interaction, the user may be required to observe, browse, read and comprehend an interaction interface presented to the user by the eye control system. This process requires certain time to be consumed, and thus a gaze duration required by the user to gaze on a target position to give an instruction is mismatched with a practical gaze duration of the user. For example, a duration when the user gazes at an icon A reaches a preset duration and the eye control system determines that the user gives an instruction, but the user is not intended to give the instruction at this time. Particularly for a disabled user, a time required to observe the interaction interface is relatively long for a physical cause, and then the eye control system mistakenly determines that the user gives an instruction, thereby causing a misoperation.

For the problem that an eye movement instruction given by a user may not be recognized accurately by an existing eye movement interaction method, there is yet no effective solution proposed at present.

### SUMMARY

According to an aspect of the embodiments of the disclosure, a method for controlling an interaction control object by eye gaze is provided, which includes that: at least one interaction control object required by interaction of a target application is displayed, the interaction control object required by interaction including an information association module and an information determination module, the information association module being configured to receive a selection instruction for selecting the interaction control object required by interaction from a user and the information determination module being configured to receive a confirmation instruction for confirming the interaction control object required by interaction from the user; a first gaze duration associated with the information association module is determined according to gaze information of eye gaze; when it is determined that the first gaze duration reaches a first predefined duration, a second gaze duration associated with the information determination module is acquired; and when it is determined that the second gaze duration reaches a second predefined duration, an operation corresponding to the interaction control object required by interaction is completed.

In an alternative embodiment, the method for controlling the interaction control object by eye gaze further includes that: multiple eye images are acquired; an eye gaze feature is extracted from the multiple eye images; and the gaze information of eye gaze is determined through the eye gaze feature.

In an alternative embodiment, the gaze information is configured to determine a gaze position and gaze duration of the user.

In an alternative embodiment, the method for controlling the interaction control object by eye gaze further includes that: the information association module and the information determination module are controlled to be displayed at the same time.

In an alternative embodiment, the method for controlling the interaction control object by eye gaze further includes that: under the condition that the first gaze duration reaches the first predefined duration associated with the information association module, the information determination module is displayed.

In an alternative embodiment, the method for controlling the interaction control object by eye gaze further includes that: amplification processing is performed on the information association module; and the amplified information association module is displayed.

In an alternative embodiment, the information determination module includes multiple subunits, and the method for controlling the interaction control object by eye gaze further includes that: under the condition that the first gaze duration reaches the first predefined duration, the multiple subunits are displayed; the unit required by interaction, that the user gazes at, in the multiple subunits is determined; the second gaze duration when the user gazes at the unit required by interaction is acquired; and under the condition that the second gaze duration reaches the second predefined duration, an operation corresponding to the unit required by interaction is controlled.

According to another aspect of the embodiments of the disclosure, a method for controlling an interaction control object by eye gaze is also provided, which includes that: a third gaze duration for a target application is detected; when the third gaze duration reaches a third predefined duration, an interaction control object associated with the target application is displayed; and when a fourth gaze duration for gazing on the interaction control object reaches a fourth predefined duration, it is determined that the target application is selected, and the target application is run.

According to another aspect of the embodiments of the disclosure, a system for controlling an interaction control object by eye gaze is provided, which includes: a data acquisition device, configured to acquire gaze information of eye gaze of a user; a display device, configured to display at least one interaction control object required by interaction of a target application, the interaction control object required by interaction including an information association module and an information determination module, the information association module being configured to receive a selection instruction for selecting the interaction control object required by interaction from a user and the information determination module being configured to receive a confirmation instruction for confirming the interaction control object required by interaction from the user; and a processing device, connected with the data acquisition device and the display device and configured to determine a first gaze duration associated with the information association module according to gaze information of eye gaze, when it is determined that the first gaze duration reaches a first predefined duration, acquire a second gaze duration associated with the information determination module and, when it is determined that the second gaze duration reaches a second predefined duration, complete an operation corresponding to the interaction control object required by interaction.

According to another aspect of the embodiments of the disclosure, a device for controlling an interaction control object by eye gaze is provided, which includes: a display module, configured to display at least one interaction control object required by interaction of a target application, the interaction control object required by interaction including an information association module and an information determination module, the information association module being configured to receive a selection instruction for selecting the interaction control object required by interaction from a user and the information determination module being configured to receive a confirmation instruction for confirming the interaction control object required by interaction from the user; a determination module, configured to determine a first gaze duration associated with the information association module according to gaze information of eye gaze; an acquisition module, configured to, when it is determined that the first gaze duration reaches a first predefined duration, acquire a second gaze duration associated with the information determination module; and a control component, configured to, when it is determined that the second gaze duration reaches a second predefined duration, complete an operation corresponding to the interaction control object required by interaction.

According to another aspect of the embodiments of the disclosure, a computer-readable storage medium is also provided, which includes a stored program, the program executing a method for controlling an interaction control object by eye gaze.

According to another aspect of the embodiments of the disclosure, a processor is also provided, which is configured to run a program, the program running a method for controlling an interaction control object by eye gaze.

### BRIEF DESCRIPTION OF THE DRAWINGS

The drawings described here are adopted to provide a further understanding to the disclosure and form a part of the application. Schematic embodiments of the disclosure and descriptions thereof are adopted to explain the disclosure and not intended to form improper limits to the disclosure. In the drawings:

FIG. 1 is a flowchart of a method for controlling an interaction control object by eye gaze according to an embodiment of the disclosure;

FIG. 2 is a structure diagram of a system for controlling an interaction control object by eye gaze according to an embodiment of the disclosure;

FIG. 3 is an optional schematic diagram of an interaction interface according to an embodiment of the disclosure;

FIG. 4 is an optional schematic diagram of an interaction interface according to an embodiment of the disclosure;

FIG. 5 is an optional schematic diagram of an interaction interface according to an embodiment of the disclosure;

FIG. 6 is an optional schematic diagram of an interaction interface according to an embodiment of the disclosure;

FIG. 7 is an optional schematic diagram of an interaction interface according to an embodiment of the disclosure;

FIG. 8 is an optional schematic diagram of an interaction interface according to an embodiment of the disclosure;

FIG. 9 is an optional schematic diagram of an interaction interface according to an embodiment of the disclosure;

FIG. 10 is a structure diagram of a device for controlling an interaction control object by eye gaze according to an embodiment of the disclosure; and

FIG. 11 is a flowchart of a method for controlling an interaction control object by eye gaze according to an embodiment of the disclosure.

### DETAILED DESCRIPTION OF THE EMBODIMENTS

In order to make those skilled in the art understand the solutions of the disclosure better, the technical solutions in the embodiments of the disclosure will be clearly and completely described below in combination with the drawings in the embodiments of the disclosure. It is apparent that the described embodiments are not all embodiments but only a part of the embodiments of the disclosure. All other embodiments obtained by those of ordinary skill in the art based on the embodiments in the disclosure without creative work shall fall within the scope of protection of the disclosure.

It is to be noted that the terms like “first” and “second” in the specification, the claims and the accompanying drawings of the disclosure are used for differentiating the similar objects, but do not have to describe a specific order or a sequence. It is to be understood that data used like this may be exchanged under a proper condition for implementation of the embodiments of the disclosure described here in sequences besides those shown or described herein. In addition, terms “include” and “have” and any transformation thereof are intended to cover nonexclusive inclusions. For example, a process, method, system, product or device including a series of steps or units is not limited to those clearly listed steps or units, but may include other steps or units which are not clearly listed or inherent in the process, the method, the system, the product or the device.

### Embodiment 1

According to the embodiment of the disclosure, an embodiment of a method for controlling an interaction control object by eye gaze is provided. It is to be noted that the steps presented in the flowchart of the drawings can be executed in a computer system like a set of computer executable instructions and, moreover, although a logical sequence is shown in the flowchart, in some cases, the presented or described steps can be executed in a sequence different from that described here.

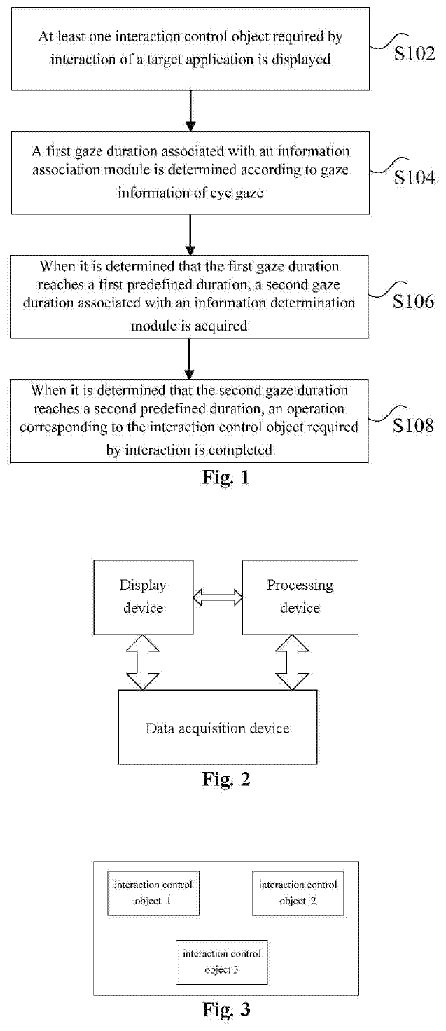

FIG. 1 is a flowchart of a method for controlling an interaction control object by eye gaze according to an embodiment of the disclosure. As shown in FIG. 1, the method includes the following steps.

In S102, at least one interaction control object required by interaction of a target application is displayed, the interaction control object required by interaction including an information association module and an information determination module.

It is to be noted that an eye control system may execute the method for controlling the interaction control object by eye gaze in the embodiment. FIG. 2 is an optional structure diagram of an eye control system. It may be seen from FIG. 2 that the eye control system includes a display device, a processing device and a data acquisition device. The data acquisition device at least includes an infrared lamp and an image sensor. The infrared lamp is configured to project infrared light to eyes of a user. The image sensor is configured to acquire a glint image formed by projection of the infrared light to a cornea of the user. It may be understood by those skilled in the art that the infrared lamp is only an example of a light source configured to form corneal reflection. Wherein the glint image refers to a cornea reflection of intense virtual images of the designated light sources which can be captured by sensors of cameras.

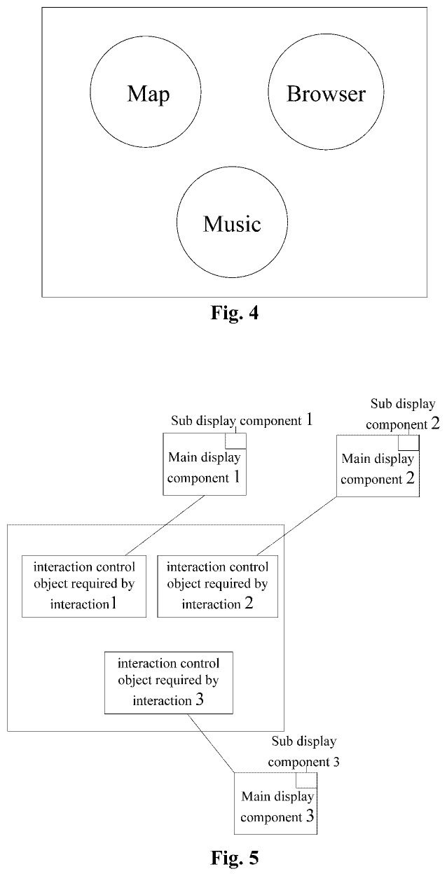

In addition, the display device (for example, a display screen) is configured to display an interaction interface. The at least one interaction control object required by interaction is displayed on the interaction interface. For example, the interaction interface shown in FIG. 3 includes three interaction control objects required by interaction, i.e., a interaction control object 1 required by interaction, a interaction control object 2 required by interaction and a interaction control object 3 required by interaction respectively. It is to be noted that the interaction control object required by interaction may be, but not limited to, an icon of an application program or software program on the display device. For example, the interaction interface shown in FIG. 4 includes an icon corresponding to a map application, an icon corresponding to a browser and an icon corresponding to music. Moreover, the application program or the software program may be installed in a computer-readable storage medium of the processing device in the eye control system or an external computer-readable storage medium and may be executed by the processing device.

In addition, it is also to be noted that the information association module in S102 is configured to receive a selection instruction for selecting the interaction control object required by interaction from a user. When gaze information of eye gaze of the user on the information association module meets a preset condition, the information association module may receive the selection instruction. The information determination module is configured to receive a confirmation instruction for confirming the interaction control object required by interaction from the user. When gaze information of eye gaze of the user on the information determination module meets a preset condition, the information determination module may receive the confirmation instruction.

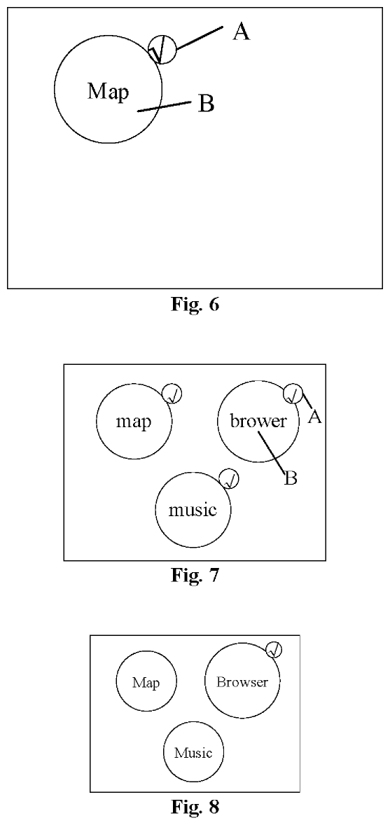

Optionally, the information association module of the interaction control object required by interaction is a main display module, and the information determination module is a sub display module. As shown in FIG. 5, each interaction control object required by interaction corresponds to a main display module and a sub display module. For example, a main display module 1 and a sub display module 1 control the interaction control object 1 required by interaction, a main display module 2 and a sub display module 2 control the interaction control object 2 required by interaction, and a main display module 3 and a sub display module 3 control the interaction control object 3 required by interaction. Optionally, FIG. 6 is an optional schematic diagram of an interaction interface, A is a main display module of a map control and B is a sub display module of the map control.

Wherein, the main display module may be an actual object, for example, a website link, or an icon which corresponding to an application. The sub display module may be a display sub-area in the area of the main display module, or an icon added in the area of the main display module.

In S104, a first gaze duration associated with the information association module is determined through gaze information of eye gaze.

The gaze information in S104 is configured to determine a gaze position and gaze duration of the user. Optionally, the data acquisition device in the eye control system may acquire an eye image and obtain the gaze information of eye gaze according to the eye image. Specifically, the user gazes at the icon corresponding to the application program or the software program in the display device. For example, the user gazes at the music icon in FIG. 4. In such case, the image sensor in the data acquisition device may acquire multiple eye images obtained by projection of the infrared lamp to the eyes of the user and determine an eye gaze feature of the user according to the multiple eye images. Then, the data acquisition device sends the obtained eye gaze feature to the processing device. The processing device may calculate the gaze information of the user according to the eye gaze feature and determine whether the user is gazing on an information association module of a certain application according to a position of a gaze point. For example, the processing device determines that the position of the gaze point is in a region where an information association module of the map control, and then may determine that the user is gazing on the information association module of the map control and acquire the first gaze duration when the user gazes at the information association module.

In S106, when it is determined that the first gaze duration reaches a first predefined duration, a second gaze duration associated with the information determination module is acquired.

It is to be noted that, after it is determined that the user is gazing on the information association module of the interaction control object required by interaction, a timer in the processing device starts timing to record the duration when the user gazes at the information association module of the interaction control object required by interaction. Under the condition that the first gaze duration when the user gazes at the information association module of the interaction control object required by interaction reaches the first predefined duration, the processing device judges whether the user is gazing on the information determination module according to eye movement data. A method by which a processor judges whether the user is gazing on the information determination module is the same as a method for judging whether the user is gazing on the information association module and will not be elaborated herein. When it is determined that the user is gazing on the information determination module, the timer in the processor starts timing to record the second gaze duration when the user gazes at the information determination module of the interaction control object required by interaction.

In S108, when it is determined that the second gaze duration reaches a second predefined duration, an operation corresponding to the interaction control object required by interaction is completed.

It is to be noted that the interaction control object required by interaction may be controlled only when the second gaze duration when the user gazes at the information determination module of the interaction control object required by interaction is longer than the second predefined duration. If the duration when the user gazes at information association module of the interaction control object required by interaction has reached the first predefined duration but the second duration for gazing on the information determination module has yet not reached the second predefined duration, the processing device may not control the interaction control object required by interaction.

It may be seen from the above content that the sub display module is arranged based on the existing main display module, the sub display module independently receives and executes the instruction given by the user and the instruction for the user may be executed only when the duration when the user gazes at the sub display module reaches the preset duration, so that the problem of misjudgment caused by the fact that a gaze duration when the user accidentally gazes at the interaction control object required by interaction reaches the preset duration is effectively solved.

Based on the solution limited by S102 to S108, it may be learned about that a manner of controlling the interaction control object required by interaction based on gaze durations when a user gazes at different parts of the interaction control object required by interaction is adopted. The first gaze duration associated with the information association module is determined through the gaze information of eye gaze; then, when it is determined that the first gaze duration reaches the first predefined duration, the second gaze duration associated with the information determination module is acquired; and finally, when it is determined that the second gaze duration reaches the second predefined duration, the operation corresponding to the interaction control object required by interaction is completed, the interaction control object required by interaction including the information association module and the information determination module.

It is easy to be noted that, in the application, the information determination module is independently arranged to receive the instruction from the user, namely the instruction for the user may be executed only when the gaze duration when the user gazes at the information determination module of the interaction control object required by interaction reaches the preset duration. It may be seen that the instruction given by the user is only associated with the information determination module of the interaction control object required by interaction and an operation of the instruction given by the user may be accurately received by interaction between the user and the interaction control object receiving the confirmation instruction for the user, so that misjudgment caused by confusion with a gaze duration when the user observes and browses the interaction control object required by interaction is avoided.

It may be seen from the above content that, according to the method for controlling the interaction control object by eye gaze, a purpose of recognizing a control instruction given by the user through the eyes is achieved, so that a technical effect of improving accuracy of the control instruction given by the user through the eyes is achieved, and the technical problem that an eye movement instruction given by the user may not be recognized accurately by an existing eye movement interaction method is further solved.

In an optional solution, before the first gaze duration associated with the information association module is determined through the gaze information of eye gaze, the eye control system further acquires multiple eye images, extracts an eye gaze feature from the multiple eye images and then determines the gaze information of eye gaze through the eye gaze feature.

It is to be noted that, in the process, the eye gaze feature may include, but not limited to, a central position of a pupil, a size of the pupil, a central position of a light spot on a cornea, the number of light spots on the cornea and the like.

Optionally, after the gaze information of eye gaze is determined through the eye gaze feature, the processing device may determine whether the user is gazing on a corresponding part (for example, the information association module or the information determination module) of the interaction control object required by interaction according to the gaze information, which may specifically include the following steps.

In S1040, a range of the information association module or information determination module of the interaction control object required by interaction is acquired.

In S1044, it is determined according to the gaze position in the gaze information and the range of the information association module or the information determination module that the user is gazing on the information association module or the information determination module.

Specifically, the processing device may acquire a regional range where each interaction control object required by interaction displayed on the display device is located, the regional range of each interaction control object required by interaction including a first region of the information association module and a second region of the information determination module. Meanwhile, the processing device may process the gaze information to further determine the gaze position of the user on the processing device. Then, the processing device matches the obtained gaze position and a regional range where the information association module of the interaction control object required by interaction on the display device is located, and if the gaze position is in the first region of the information association module, may determine that the user is gazing on the interaction control object required by interaction. If the gaze duration is longer than the first predefined duration, the processing device determines that the user gives the selection instruction to the interaction control object required by interaction. The condition that the user gazes at the information determination module includes the same content and will not be elaborated herein.

It is to be noted that, under a normal circumstance, the information association module of the interaction control object required by interaction is always displayed in the display screen but the information determination module of the interaction control object required by interaction may be hidden before the first gaze duration reaches the first predefined duration. In this scenario, under the condition that the first gaze duration when the user gazes at the information association module of the interaction control object required by interaction reaches the first predefined duration, the processing device is required to control the information determination module of the interaction control object required by interaction to be displayed and then judge whether the user gives the confirmation instruction according to the duration when the user gazes at the information determination module.

In an optional solution, the processing device controls the information association module and information determination module of the interaction control object required by interaction to be displayed at the same time, namely display contents corresponding to the information association module and information determination module of the interaction control object required by interaction are always displayed. For example, FIG. 7 is a schematic diagram of an interaction interface. Two parts of each interaction control object required by interaction are displayed, i.e., the display content corresponding to the information determination module configured to receive the confirmation instruction of the user (a content displayed in a region A of the browser control object) and the display content corresponding to the information association module configured to receive the selection instruction of the user (i.e., a content displayed in a region B of the browser control object). If the user is expected to start the browser, the user is only required to gaze on the region A of the browser control object, the data acquisition device may acquire an eye image of the user, the processing device judges a gaze position of the user according to the eye image, and when a gaze duration when the user gazes at the region A reaches the second predefined duration (for example, 1 second), the processing device determines that the user gives an instruction for determining to select the browser control object and runs the browser.

In another optional solution, the display contents of the information association module and information determination module of the interaction control object required by interaction are not displayed at the same time, and only when the user gazes at the information association module for a certain period of time and the duration when the user gazes at the information determination module also reaches the second predefined duration, the processing device may control the interaction control object required by interaction, namely the information determination module is displayed under the condition that the first gaze duration reaches the first predefined duration associated with the information association module.

Specifically, the data acquisition device acquires the eye image of the user and sends the acquired eye image to the processing device. The processing device analyzes the eye image and determines the gaze information of the user according to an analysis result. If the processing device detects that the gaze duration when the user gazes at the display content corresponding to the information association module of the interaction control object required by interaction is longer than the first predefined duration (for example, 2 seconds), the processing device determines that the user may be required to start or run the interaction control object required by interaction, and in such case, the processing device controls the display content corresponding to the information determination module to be displayed. As shown in FIG. 8, if the gaze duration when the user gazes at the browser control object exceeds 2 seconds, an icon with a tick “√” is displayed on the display device, the icon corresponding to the information determination module of the browser control object. Then, the processing device further detects whether the user gazes at display content corresponding to the information determination module (for example, the icon with the tick “√” in FIG. 8) and, if it is detected that the user gazes at the display content corresponding to the information determination module, further statistically records the gaze duration of the user. If the gaze duration is longer than the second predefined duration (for example, 1 second), the processing device determines that the user gives the instruction for determining to select the browser control object and runs the browser.

It is to be noted that, under the condition that the information determination module includes multiple subunits, the interaction control object required by interaction may further be controlled by the following method.

In S1080, under the condition that the first gaze duration reaches the first predefined duration, the multiple subunits are displayed.

In S1082, the unit required by interaction, that the user gazes at, in the multiple subunits is determined.

In S1084, the second gaze duration when the user gazes at the unit required by interaction is acquired.

In S1086, under the condition that the second gaze duration reaches the second predefined duration, an operation corresponding to the unit required by interaction is controlled.

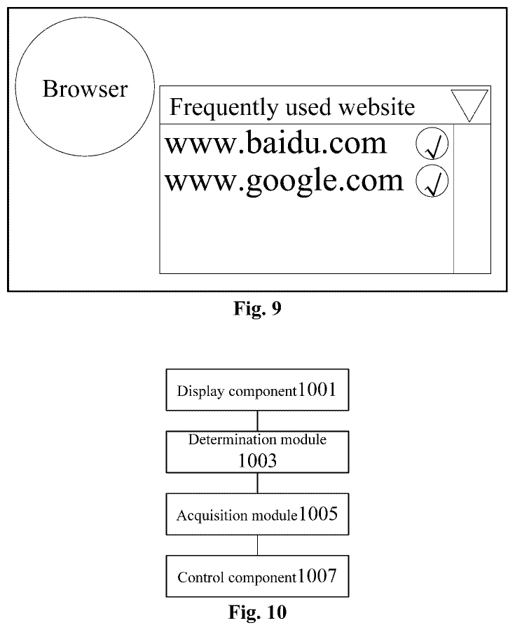

Specifically, the display content corresponding to the information determination module is displayed in form of a drop-down box. Each subunit is an alternate content of the interaction control object required by interaction. For example, subunits corresponding to the browser control object in FIG. 9 are multiple websites. Optionally, descriptions are made with FIG. 9 as an example. The data acquisition device acquires eye movement data of the user and sends the acquired eye movement data to the processing device. The processing device analyzes the eye movement data and determines a gaze point of the user according to an analysis result. If the processing device detects that the gaze duration when the user gazes at the display content corresponding to the information association module of the browser control object is longer than the first predefined duration (for example, 2 seconds), the processing device determines that the user may be required to start or run the browser control object, and in such case, the processing device controls the display content corresponding to the information determination module to be displayed. As shown in FIG. 9, if the gaze duration when the user gazes at the browser control object exceeds 2 seconds, the browser control object displays the content of the drop-down box, each display content in the drop-down box (website in FIG. 9) corresponding to a subunit (for example, an icon with a tick “√” in FIG. 9), and when the user gazes at one subunit and a gaze duration is greater than the second predefined duration (for example, 1 second), the processing device determines that the user gives the instruction for determining to select the browser control object, runs the browser and controls the browser to jump to a webpage corresponding to the website selected by the user.

It is to be noted that, for improving a user experience of the user in using the eye control system, the processing device, after determining according to the eye movement data that the user gazes at the information determination module of the interaction control object required by interaction, namely determining that the user may be intended to give the confirmation instruction, further performs amplification processing on the information association module of the interaction control object required by interaction and controls the display device to display the amplified information association module. For example, the user gazes at the display content of the information association module of the browser control object (the gaze duration may have yet not reached the second predefined duration), and in such case, the processing device determines that the user may give the confirmation instruction and amplifies the browser control object for displaying to make such a prompt that the user is about to enable the interaction control object required by interaction.

### Embodiment 2

According to the embodiment of the disclosure, an embodiment of a system for controlling an interaction control object by eye gaze is also provided. The system may execute the method for controlling the interaction control object by eye gaze in embodiment 1. In addition, FIG. 2 is a structure diagram of a system for controlling an interaction control object by eye gaze according to an embodiment of the disclosure. As shown in FIG. 2, the system includes a data acquisition device, a processing device and a display device.

The data acquisition device is configured to acquire gaze information of eye gaze of a user. The display device is configured to display at least one interaction control object required by interaction of a target application, the interaction control object required by interaction including an information association module and an information determination module. The processing device is connected with the data acquisition device and the display device, and is configured to determine a first gaze duration associated with the information association module according to gaze information of eye gaze, when it is determined that the first gaze duration reaches a first predefined duration, acquire a second gaze duration associated with the information determination module and, when it is determined that the second gaze duration reaches a second predefined duration, complete an operation corresponding to the interaction control object required by interaction.

It is to be noted that the data acquisition device at least includes an infrared lamp and an image sensor. The infrared lamp is configured to project infrared light to eyes of a user. The image sensor is configured to acquire a light spot image formed by projection of the infrared light to a cornea of the user. The display device (for example, a display screen) is configured to display an interaction interface. The interaction interface is configured to display the at least one interaction control object required by interaction. For example, the interaction interface shown in FIG. 3 includes three controls required by interaction, i.e., a interaction control object 1 required by interaction, a interaction control object 2 required by interaction and a interaction control object 3 required by interaction respectively. It is to be noted that the interaction control object required by interaction may be, but not limited to, an icon of an application program or software program on the display device. For example, the interaction interface shown in FIG. 4 includes an icon corresponding to a map application, an icon corresponding to a browser and an icon corresponding to music. Moreover, the application program or the software program may be installed in a computer-readable storage medium of the processing device in the eye control system or an external computer-readable storage medium and may be executed by the processing device.

In addition, it is also to be noted that the interaction control object required by interaction includes two parts, i.e., the information association module and the information determination module. The information association module is configured to receive a selection instruction for selecting the interaction control object required by interaction from a user. When gaze information of eye gaze of the user on the information association module meets a preset condition, the information association module may receive the selection instruction. The information determination module is configured to receive a confirmation instruction for confirming the interaction control object required by interaction from the user. When gaze information of eye gaze of the user on the information determination module meets a preset condition, the information determination module may receive the confirmation instruction.

Optionally, the information association module of the interaction control object required by interaction is a main display module, and the information determination module is a sub display module. As shown in FIG. 5, each interaction control object required by interaction corresponds to a main display module and a sub display module. For example, a main display module 1 and a sub display module 1 control the control object 1 required by interaction, a main display module 2 and a sub display module 2 control the control object 2 required by interaction, and a main display module 3 and a sub display module 3 control the control object 3 required by interaction. Optionally, FIG. 6 is an optional schematic diagram of an interaction interface, A is a main display module of a map control object and B is a sub display module of the map control object.

It may be seen from the above that the first gaze duration associated with the information association module is determined through the gaze information of eye gaze; then whether the first gaze duration reaches the first predefined duration associated with the information association module is determined, and when it is determined that the first gaze duration reaches the first predefined duration, the second gaze duration associated with the information determination module is acquired; and finally, whether the second gaze duration reaches the second predefined duration associated with the information determination module is determined, and when it is determined that the second gaze duration reaches the second predefined duration, the operation corresponding to the interaction control object required by interaction is completed, the interaction control object required by interaction including the information association module and the information determination module.

It is easy to be noted that, in the application, the information determination module is independently arranged to receive the instruction of the user, namely the instruction of the user may be executed only when the gaze duration when the user gazes at the information determination module of the interaction control object required by interaction reaches the preset duration. It may be seen that the instruction given by the user is only associated with the information determination module of the interaction control object required by interaction and an operation of the instruction given by the user may be accurately received by interaction between the user and the interaction control object receiving the confirmation instruction of the user, so that misjudgment caused by confusion with a gaze duration when the user observes and browses the interaction control object required by interaction is avoided.

It may be seen from the above content that, according to the method for controlling the interaction control object by eye gaze, a purpose of recognizing a control instruction given by the user through the eyes is achieved, so that a technical effect of improving accuracy of the control instruction given by the user through the eyes is achieved, and the technical problem that an eye movement instruction given by the user may not be recognized accurately by an existing eye movement interaction method is further solved.

In an optional solution, before the first gaze duration associated with the information association module is determined through the gaze information of eye gaze, the eye control system further acquires multiple eye images, extracts an eye gaze feature from the multiple eye images and then determines the gaze information of eye gaze through the eye gaze feature. The gaze information is configured to determine a gaze position and gaze duration of the user.

In an optional solution, before whether the second gaze duration reaches the second predefined duration associated with the information determination module is determined, the processing device is required to control the information determination module to be displayed. The processing device may control the information determination module to be displayed in any one of the following two manners.

A first manner: the information association module and information determination module of the interaction control object required by interaction are controlled to be displayed at the same time. In this manner, display contents corresponding to the information association module and information determination module of the interaction control object required by interaction are always displayed.

A second manner: under the condition that the first gaze duration reaches the first predefined duration associated with the information association module, the information determination module is displayed.

It is to be noted that, under the condition that the second manner is adopted, the information determination module may further include multiple subunits. If the first gaze duration reaches the first predefined duration, the processing device controls the display device to display the multiple subunits, determines the unit required by interaction, that the user gazes at, in the multiple subunits, then acquires the second gaze duration when the user gazes at the unit required by interaction and further judges magnitudes of the second gaze duration and the second predefined duration. If the second gaze duration reaches the second predefined duration, the processing device starts the unit required by interaction and controls an operation corresponding to the unit required by interaction.

It is to be noted that, for improving a user experience of the user in using the eye control system, the processing device, after determining according to the eye movement data that the user gazes at the information determination module of the interaction control object required by interaction, namely determining that the user may be intended to give the confirmation instruction, further performs amplification processing on the information association module of the interaction control object required by interaction and controls the display device to display the amplified information association module. For example, the user gazes at the display content of the information association module of the browser control object (the gaze duration may have yet not reached the second predefined duration), and in such case, the processing device determines that the user may give the confirmation instruction and amplifies the browser control object for displaying to make such a prompt that the user is about to enable the interaction control object required by interaction.

### Embodiment 3

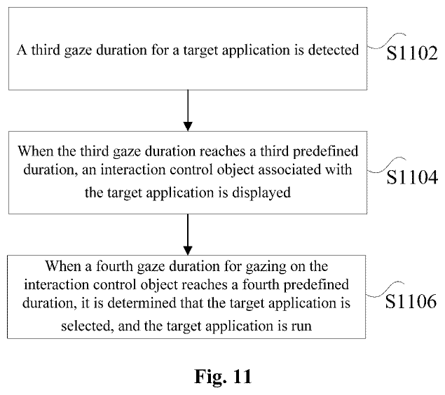

According to the embodiment of the disclosure, an embodiment of a device for controlling an interaction control object by eye gaze is also provided. The device may execute the method for controlling the interaction control object by eye gaze in embodiment 1. FIG. 10 is a structure diagram of a device for controlling an interaction control object by eye gaze according to an embodiment of the disclosure. As shown in FIG. 10, the device includes a display module 1001, a Determination component 1003, an acquisition module 1005 and a control component 1007.

The display module 1001 is configured to display at least one interaction control object required by interaction of a target application, the interaction control object required by interaction including an information association module and an information determination module. The determination component 1003 is configured to determine a first gaze duration associated with the information association module according to gaze information of eye gaze. The acquisition module 1005 is configured to, when it is determined that the first gaze duration reaches a first predefined duration, acquire a second gaze duration associated with the information determination module. The control component 1007 is configured to, when it is determined that the second gaze duration reaches a second predefined duration, complete an operation corresponding to the interaction control object required by interaction.

It is to be noted that the information association module is configured to receive a selection instruction for selecting the interaction control object required by interaction from a user and the information determination module is configured to receive a confirmation instruction for confirming the interaction control object required by interaction from the user.

It is to be noted that the display module 1001, the determination component 1003, the acquisition module 1005 and the control component 1007 correspond to S102 to S108 in embodiment 1 and the four modules implement an example and application scenario the same as those implemented by the corresponding steps but are not limited to the contents disclosed in embodiment 1.

In an optional solution, the device for controlling the interaction control object by eye gaze further includes a first acquisition module, an extraction module and a first determination module. The first acquisition module is configured to acquire multiple eye images. The extraction module is configured to extract an eye gaze feature from the multiple eye images. The first determination module is configured to determine the gaze information of eye gaze through the eye gaze feature. The gaze information is configured to determine a gaze position and gaze duration of the user.

In an optional solution, the device for controlling the interaction control object by eye gaze further includes a first display module. The first display module is configured to control the information association module and information determination module to be displayed at the same time.

In an optional solution, the device for controlling the interaction control object by eye gaze further includes a second display module. The second display module is configured to, under the condition that the first gaze duration reaches the first predefined duration associated with the information association module, display the information determination module.

In an optional solution, the device for controlling the interaction control object by eye gaze further includes a processing module and a third display module. The processing module is configured to perform amplification processing on the information association module. The third display module is configured to display the amplified information association module.

In an optional solution, the information determination module includes multiple subunits, and the control component includes a fourth display module, a second determination module, a second acquisition module and a first control component. The fourth display module is configured to, under the condition that the first gaze duration reaches the first predefined duration, display the multiple subunits. The second determination module is configured to determine the unit required by interaction, that the user gazes at, in the multiple subunits. The second acquisition module is configured to acquire the second gaze duration when the user gazes at the unit required by interaction. The first control component is configured to, under the condition that the second gaze duration reaches the second predefined duration, control an operation corresponding to the unit required by interaction.

It is to be noted that the fourth display module, the second determination module, the second acquisition module and the first control component correspond to S1080 to S1086 in embodiment 1 and the four modules implement an example and application scenario the same as those implemented by the corresponding steps but are not limited to the contents disclosed in embodiment 1.

### Embodiment 4

According to another aspect of the embodiment of the disclosure, a computer-readable storage medium is also provided, which includes a stored program, the program executing the method for controlling the interaction control object by eye gaze in embodiment 1.

### Embodiment 5

According to another aspect of the embodiment of the disclosure, a processor is also provided, which is configured to run a program, the program running the method for controlling the interaction control object by eye gaze in embodiment 1.

### Embodiment 6

According to the embodiment of the disclosure, an embodiment of a method for controlling an interaction control object by eye gaze is also provided. FIG. 11 is a flowchart of a method for controlling an interaction control object by eye gaze according to an embodiment of the disclosure. As shown in FIG. 11, the method includes the following steps.

In S1102, a third gaze duration for a target application is detected. In S1104, when the third gaze duration reaches a third predefined duration, an interaction control object associated with the target application is displayed.

In S1106, when a fourth gaze duration for gazing on the interaction control object reaches a fourth predefined duration, it is determined that the target application is selected, and the target application is run.

It is to be noted that the system for controlling the interaction control object by eye gaze in embodiment 2, i.e., the eye control system mentioned in embodiment 1, may serve as an execution body of the embodiment. In addition, the target application includes at least one interaction control object required by interaction, the interaction control object required by interaction includes an information association module and an information determination module, the information association module is configured to receive a selection instruction for selecting the interaction control object required by interaction from a user, and the information determination module is configured to receive a confirmation instruction for confirming the interaction control object required by interaction from the user.

Optionally, the third gaze duration for the target application may be a gaze duration of a user for the information association module of the target application. For example, when the gaze duration when the user gazes at the information association module meets the third predefined duration, the information association module may receive the selection instruction. In addition, the interaction control object required by interaction displayed in S1104 and associated with the target application may be the information determination module of the target application. Specifically, the eye control system, after receiving the selection instruction, controls the information determination module associated with the target application to be displayed. For example, in FIG. 8, a gaze duration when the user gazes at a browser control exceeds 2 seconds, an icon with a tick “√” is displayed on the display device, the icon corresponding to an information determination module of the browser control object. Then, the eye control system further detects whether the user gazes at a display content corresponding to the information determination module (for example, the icon with the tick “√” in FIG. 8) and, if it is detected that the user gazes at the display content corresponding to the information determination module, further statistically records the gaze duration of the user. If the gaze duration is longer than a second predefined duration (for example, 1 second), the processing device determines that the user gives an instruction for determining to select the browser control object and runs a browser.

Based on the solution limited by S1102 to S1106, it may be learned about that the third gaze duration for the target application is detected, when the third gaze duration reaches the third predefined duration, the interaction control object associated with the target application is displayed; and when the fourth gaze duration for gazing on the interaction control object reaches the fourth predefined duration, it is determined that the target application is selected, and the target application is run.

It is easy to be noted that, in the application, the interaction control object is independently arranged to receive the instruction of the user, namely the interaction control object receiving the confirmation instruction of the user may be displayed only when the gaze duration when the user gazes at the target application reaches a preset duration and the instruction of the user may be executed only when the gaze duration when the user gazes at the interaction control object reaches a preset condition. It may be seen that the instruction given by the user is only associated with the interaction control object receiving the confirmation instruction of the user and an operation of the instruction given by the user may be accurately received by interaction between the user and the information determination module, so that misjudgment caused by confusion with a gaze duration when the user observes and browses the interaction control object required by interaction is avoided.

It may be seen from the above content that, according to the method for controlling the interaction control object by eye gaze, a purpose of recognizing a control instruction given by the user through the eyes is achieved, so that a technical effect of improving accuracy of the control instruction given by the user through the eyes is achieved, and the technical problem that an eye movement instruction given by the user may not be recognized accurately by an existing eye movement interaction method is further solved.

The sequence numbers of the embodiments of the disclosure are only adopted for description and do not represent superiority-inferiority of the embodiments.

In the embodiments of the disclosure, the descriptions of the embodiments focus on different aspects. The part which is not described in a certain embodiment in detail may refer to the related description of the other embodiments.

In some embodiments provided in the application, it is to be understood that the disclosed technical contents may be implemented in other manners. Herein, the device embodiment described above is only schematic. For example, division of the units is only division of logical functions, and other division manners may be adopted during practical implementation. For example, multiple units or components may be combined or integrated to another system, or some features may be ignored or are not executed. In addition, shown or discussed coupling, direct coupling or communication connection may be implemented through indirect coupling or communication connection of some interfaces, units or modules, and may be in an electrical form or other forms.

The units described as separate parts may or may not be separate physically, and parts displayed as units may or may not be physical units, that is, they may be located in the same place, or may also be distributed to multiple units. Part or all of the units may be selected to achieve the purpose of the solutions of the embodiments according to a practical requirement.

In addition, each functional unit in each embodiment of the disclosure may be integrated into a processing unit, each unit may also physically exist independently, and two or more than two units may also be integrated into a unit. The integrated unit may be implemented in a hardware form and may also be implemented in form of software functional unit.

If being implemented in form of software functional unit and sold or used as an independent product, the integrated unit may be stored in a computer-readable storage medium. Based on such an understanding, the technical solutions of the disclosure substantially or parts making contributions to the conventional art or all or part of the technical solutions may be embodied in form of software product. The computer software product is stored in a computer-readable storage medium, including a plurality of instructions configured to enable a computer device (which may be a personal computer, a server, a network device or the like) to execute all or part of the steps of the method in each embodiment of the disclosure. The computer-readable storage medium includes various media capable of storing program codes such as a U disk, a Read-Only Memory (ROM), a Random Access Memory (RAM), a mobile hard disk, a magnetic disk or an optical disk.

The above is only the preferred embodiment of the disclosure. It is to be pointed out that those of ordinary skill in the art may also make a number of improvements and embellishments without departing from the principle of the disclosure and these improvements and embellishments shall also fall within the scope of protection of the disclosure.

What is claimed is:

1. A method for controlling an interaction control object by eye gaze, comprising:
displaying at least one interaction control object required by interaction of a target application, the interaction control object required by interaction comprises an information association module and an information determination module, the information association module is configured to receive a selection instruction for selecting the interaction control object required by interaction from a user and the information determination module is configured to receive a confirmation instruction for confirming the interaction control object required by interaction from the user;
determining a first gaze duration associated with the information association module through gaze information of eye gaze;
when it is determined that the first gaze duration reaches a first predefined duration, acquiring a second gaze duration associated with the information determination module; and
when it is determined that the second gaze duration reaches a second predefined duration, completing an operation corresponding to the interaction control object required by interaction.

2. The method as claimed in claim 1, before determining the first gaze duration associated with the information association module through the gaze information of eye gaze, further comprising:
acquiring multiple eye images;
extracting an eye gaze feature from the multiple eye images; and
determining the gaze information of eye gaze through the eye gaze feature.

3. The method as claimed in claim 2, wherein the gaze information is used for determining a gaze position and gaze duration of the user.

4. The method as claimed in claim 1, before determining whether the second gaze duration reaches the second predefined duration associated with the information determination module, further comprising:
controlling the information association module and the information determination module to be displayed at the same time.

5. The method as claimed in claim 1, before determining whether the second gaze duration reaches the second predefined duration associated with the information determination module, further comprising:
under a condition that the first gaze duration reaches the first predefined duration associated with the information association module, displaying the information determination module.

6. The method as claimed in claim 4, after displaying the information determination module, further comprising:
performing amplification processing on the information association module; and
displaying an amplified information association module.

7. The method as claimed in claim 1, wherein the information determination module comprises multiple subunits, and completing the operation corresponding to the interaction control object required by interaction when it is determined that the second gaze duration reaches the second predefined duration comprises:
under a condition that the first gaze duration reaches the first predefined duration, displaying the multiple subunits;
determining the unit required by interaction, that the user gazes at, in the multiple subunits;
acquiring the second gaze duration when the user gazes at the unit required by interaction; and
under a condition that the second gaze duration reaches the second predefined duration, controlling an operation corresponding to the unit required by interaction.

8. A method for controlling an interaction control object by eye gaze, comprising:
detecting a third gaze duration for a target application;
when the third gaze duration reaches a third predefined duration, displaying an interaction control object associated with the target application; and
when a fourth gaze duration for gazing on the interaction control object reaches a fourth predefined duration, determining that the target application is selected, and running the target application.

9. A system for controlling an interaction control object by eye gaze, comprising:
a data acquisition device, configured to acquire gaze information of eye gaze of a user;
a display device, configured to display at least one interaction control object required by interaction of a target application, the interaction control object required by interaction comprising an information association module and an information determination module, the information association module being configured to receive a selection instruction for selecting the interaction control object required by interaction from a user and the information determination module being configured to receive a confirmation instruction for confirming the interaction control object required by interaction from the user; and
a processing device, connected with the data acquisition device and the display device and configured to determine a first gaze duration associated with the information association module according to gaze information of eye gaze, when it is determined that the first gaze duration reaches a first predefined duration, acquire a second gaze duration associated with the information determination module and, when it is determined that the second gaze duration reaches a second predefined duration, complete an operation corresponding to the interaction control object required by interaction.

10. (canceled)

11. A computer-readable storage medium, comprising a stored program, the program running to control equipment where the computer-readable storage medium is located to execute the method for controlling the interaction control object by eye gaze as claimed in claim 1.

12. A processor, configured to run a program, the program running the method for controlling the interaction control object by eye gaze as claimed in claim 1.

13. The method as claimed in claim 5, after displaying the information determination module, further comprising:
performing amplification processing on the information association module; and
displaying an amplified information association module.

14. The method as claimed in claim 1, wherein the information association module of the interaction control object required by interaction is a main display module, and the information determination module is a sub display module, each interaction control object required by interaction corresponds to a main display module and a sub display module.

15. The method as claimed in claim 1, wherein the information association module is always displayed in the display screen and the information determination module is hidden before the first gaze duration reaches the first predefined duration.

16. The system as claimed in claim 9, wherein the information association module of the interaction control object required by interaction is a main display module, and the information determination module is a sub display module, each interaction control object required by interaction corresponds to a main display module and a sub display module.

17. The device as claimed in claim 10, wherein the information association module is always displayed in the display screen and the information determination module is hidden before the first gaze duration reaches the first predefined duration.

18. The device as claimed in claim 10, the control component is further configured to, after displaying the information determination module, perform amplification processing on the information association module; and display an amplified information association module.

19. The system as claimed in claim 9, the processing device is further configured to, after displaying the information determination module, perform amplification processing on the information association module; and display an amplified information association module.

20. A processor, configured to run a program, the program running the method for controlling the interaction control object by eye gaze as claimed in claim 2.
